(19) United States
(12) Patent Application Publication
(10) Pub. No.: US 2005/0022132 A1
(43) Pub. Date: Jan. 27, 2005

(54) Managing objects and sharing information among communities

(75) Inventors: Amir Herzberg, Ramat Efal (IL); Yiftach Ravid, Tel Aviv (IL)

Correspondence Address: VENABLE, BAETJER, HOWARD AND CIVILETTI, LLP, P.O. BOX 34385, WASHINGTON, DC, 20043-9998, US

(73) Assignee: INTERNATIONAL BUSINESS MACHINES CORPORATION, Armonk, NY (US)

(21) Appl. No.: 10/833,303

(22) Filed: Apr. 28, 2004

Related U.S. Application Data
(63) Continuation of application No. 09/522,416, filed on Mar. 9, 2000, now abandoned.

(51) Int. Cl. G09G 5/00

(52) U.S. Cl. 715/759; 715/751; 715/734; 715/853

(57) ABSTRACT

A method for managing objects for users including providing a set of attributes and a set of containers each having attributes from the set. The method further provides a user interface for dynamically assigning attributes to the objects. The method further provides for selectively displaying, through a user interface, containers and objects in the containers. An object is displayed in a container if a condition is met. The condition is applied to the attributes of the container and the attributes of the object.

### FIELD OF THE INVENTION

The present invention is in the general field of managing objects and sharing information among communities, such as sharing bookmarks of frequently used locations (URLs) among web surfers.

### LIST OF PRIOR ART

[KWRCM] Keller R. M., Wolfe S. R., Chen J. R., Rabinowitz J. L. and Mathe N., “A Bookmark Service for Organizing and Sharing URLs”, sixthinternational World Wide Web Conference, Santa Clara, Calif., USA, Apr. 7-11, 1997.

[KM] Klark, P. and Manber, U. “Developing a Personal Internet Assistant”, Proc. Conference on Educational Multimedia and Hypermedia (ED-MEDIA '95)Graz, 372-377, 1995.

[WDHS] Wittenberg, K. Das, D. Hill, W. and Stead, L., “Group Asynchronous Browsing on the World Wide Web” Fourth Additional World Wide Web Conference, Boston, Dec. 11-14, 1996.

[GNOT] Goldberg, D., Nichols, D, Oki, B. M. and Terry, D., “Using Collaborative Filtering to Weave an Information Tapestry” Communications of the ACM 35 (12), 61-70, 1992.

[SiteSeer] http://www.imana.com/Webobjects/Siteseer

[KRW] Kamiya, K., Rvscheisen, M. and Winograd, T., “Grassroots; A System Providing Uniform Framework for Communicating, Structuring, Sharing Information and Organizing People”, Fifth International World Wide Web Conference Paris, France, 6-10, 1996.

[KMMHGR] Konstan, J. Miller, B., Maltz, D., Herlocker, J., Gordon, L. and Riedl, J., “GroupLens: Applying Collaborative Filtering to Usenet News”. Communications of the ACM 40,3. (1997), 77-87.

[GJSO] David K. Gifford, Pierre Jouvelot, Mark A. Sheldon, James W. O'Toole, Jr., “Semantic File Systems” Programming Systems Research Group—MIT Laboratory for Computer Science.

[GM] Burra Gopal, Udi Manber, “Integrating Content-Based Access Mechanisms with Hierarchical File Systems”, Third Symposium on Operating Systems Design and Implementation, (OSbI '99) Usenix Association.

### BACKGROUND OF THE INVENTION

The Web is huge. Users often find locations (sites, home pages, URLs) which they feel are of potential future use. Finding their way to the same location again could be tricky, difficult and time consuming. Accordingly, surfers usually want to mark the web page of interest, making it easier to find when necessary. These marks are usually referred to as bookmarks (also as favorites, thumbnails, hotlists).

The traditional way to organized bookmarks is using a tree structure. Popular browsers (Netscape Communicator™, Netscape Navigator™ and Microsoft™ Internet Explorer) include a bookmark management tool, each using its own proprietary format for storing the bookmarks. Several stand-alone bookmark management tools have also been developed These tools allow users to design their own tree organization of bookmarks, and to enter bookmarks and manage them, as well as open them in the browser (when clicked). The tree organization is a simple and well understood way, allowing each user to organize bookmarks for easy access based on personal preferences.

These existing bookmark management tools with few exceptions noted later, are focused on helping an individual user rather than facilitating the sharing of bookmarks among users. In order to share bookmarks, users typically send the URL's or bookmark files to each other (e.g. using e-mail). This is clearly not a very efficient mechanism. Sharing of complete bookmark files is especially problematic as different tools (browsers) use different proprietary, incompatible formats. This is actually a problem even for (many) users who use multiple browsers and/or machines—e.g. users that have two operating systems or computers, and two different browsers will have four bookmark files. There are some utilities that purport to translate bookmark files among these different formats, but this procedure is burdensome and sometimes error prone

Another common approach used to share URLs is to provide them as links on specially designed web pages, referred to as web indexes (or “lists of links”). Such indexes are now commonly provided in most web sites and even in many personal homepages. Indexes may focus on the interests of a particular individual or community, on a particular subject, or be general. There are several large, mega-indexes which categorize “all the web” as a series of HTML pages. A well known example is YAHOO!™. Each index has its own tree structure, and typically offers two ways of locating URLs (i.e. bookmark); using a search utility (simple search in a database), or using the categorized folders. In the mega-indexes, users may also mark web pages to be indexed and suggest the appropriate folder.

There are several problems in sharing bookmarks using such indexes:
The indexes are provided in special web sites, rather than as a local application and files; this implies that access is substantially slower and less convenient, compared to a local bookmark management tool. Furthermore, this depends on connectivity to the index server.
The same URL may be relevant to more than one folder; furthermore, different users may prefer different arrangement of folders (e.g. top level folder “music” and sub-folder “shopping” or vice versa) or simply a different name for folders (e.g. “find” and “search”). The result is that relevant URLs are often spread cross multiple folders, as is known to every user of the popular indexes such as Yahoo!™
Users often have bookmarks that they do not wish to share, being private (e.g. including passwords) or simply user specific. A common index server does not allow such features.

Several different systems enable users to share personal bookmark collections:

Keller et al. [KWCRM] introduced the WebTagger. WebTagger was designed as a personal and community bookmarking, service, running in a web server (as CGI program). The system is a proxy based system that modifies each web page being browsed, by adding buttons for categorizing the page, querying the database, etc. To look up folders, the user needs to form a query, as there is no common or customized folder organization. Inter alia, There is no support for privacy or replication.

Klark and Manber designed the Warmlist [KM]. The application is based on sharing a common bookmark file using a shared file system (UniX™). Users can insert their own bookmarks, organize them hierarchically (using the same tree), index them, and search the file for bookmarks.

Active Notebook (Torrance) allows users to label information with conceptual classifications and organized them into a taxonomy for later browsing and retrieval. The focus of Torrance's work is on clustering documents and identifying morphological concepts (keywords). Torrance does not deal with aspects of sharing such as replication, privacy and user interface.

Wittenberg et al. created the Group Asynchronous Browsing Server [WDHS] that collects and merges user's bookmarks and then displays these merged bookmarks in a standard web browser. Their approach is that when they find the same URL in two bookmark files, they give the user a link from the folder in one bookmark file to the folder of the other bookmark file.

Collaborative filtering methods provide a means of selective information sharing by utilizing preference indicated by other users. These preferences might be inferred implicitly from the actions of others, or might be based on explicit user evaluation. See [GNOT], [SiteSeer], [KRW],[KMMHGR].

Gifford et al. [see GJSO] provides for a semantic file system which is an information storage system that provides flexible associative access to the system's contents by automatically extracting attributes from files with file type specific transducers. Associative access is provided by a conservative extension to existing tree-structured file system protocols, and by protocols that are designed specifically for content based access. Compatibility with existing, file system protocols is provided by introducing the concept of a virtual directory. Virtual directory names are interpreted as queries, and thus provide flexible associative access to files and directories in a manner compatible with existing software. Rapid attribute-based access to file system contents is implemented by automatic extraction and indexing of key properties of file system objects. The Semantic File System in accordance with the Gifford et al. publication supports various types of objects, such as documents, mails and other objects.

Gopal et al. [see GM] provides for a new file system that combines name-based and content-based access to files at the same time. The design allows both methods to be used at any time, thus preserving the benefits of both. Users can create their own name spaces based on queries, on explicit path names, or on any combination interleaved arbitrarily. All regular file operations—such as adding, deleting, or moving files—are supported in the same way, and in addition, query consistency is maintained and adapted to what the user is manually doing. One can add, remove or move results of queries, and in general handle them as if they were regular files.

The specified Gifford et al. and Gopal et al. publications offer an object management system which does not aim at handling object sharing, however offer a management scheme, which supports handling of, say, data files, by assigning attributes to the specified data files, and enabling to query the data files by the attributes. For example, extracting all data files sent To “Smith”. In a similar manner, the proposed approach may support also bookmark management.

The proposed systems of the kind disclosed in Gifford et al. and Gopal et al. publications, have some inherent limitations. For one, the attributes that are assigned to the various objects are of static nature. (e.g. for letters the fields: From:, To: etc.). In many real life applications the static nature of attributes is insufficient. Consider, for example, the specified bookmark sharing application where a given bookmark is assigned with the attribute, say IBM. A given user may now decide that the specified bookmark should also be assigned with the attribute, say security. Not only that a static attribute system would fall short in supporting such change (by this particular embodiment adding new attribute and assigning the so added attribute to an object), but obviously fails to propose a scheme for propagating this update among other members in the community. Thus, it would be expected that the specified bookmark would be reflected at other user views (associated with the same or different users) who already exploit the attribute security.

There is, accordingly, a need in the art to provide a technique, which enables to manage and possibly share objects among users, and which substantially overcomes the limitation of hitherto known techniques. There is a further a need in the art to provide a system that enables to manage objects also in a single user environment

### SUMMARY OF THE INVENTION

The invention provides for a method for managing objects for at least one user, comprising:
(a) providing a set of attributes;
(b) providing a set of containers, each associated with attributes from among said set;
(c) providing user interface for dynamically assigning attributes to said objects;
(d) selectively displaying, through a user interface, at least one container; an object is displayed in said container if a condition is met; the condition is applied to at least the following: at least one of the attributes of the container and at least one of the attribute of the object.

The invention further provides for a method for sharing objects among community of users; each user is associated with a respective set of attributes such that at least one attribute is common to at least two of said users; the method comprising executing the following steps for each user in the community:
(a) providing a user replica that includes objects that are assigned, each, with at least one attribute;
(b) providing a set of containers associated, each, with attributes from among said set;
(c) providing a user interface for generating an update in said replica;
(d) submitting the update stipulated in step c to the replicas of selected users;
(e) receiving at least one update from at least one user in the community and update said user replica with the so received update; and
(f) selectively displaying, through a user interface, at least one container; an object from the replica is displayed in said container if a condition is met; the condition is applied to at least the following: at least one of the attributes of the container and at least one of the attribute of the object.

Still further the invention provides for a system for managing objects for at least one user, comprising a processor and associated memory and display configured to perform the operations that include:
(a) providing a set of attributes;
(b) providing a set of containers, each associated with attributes from among said set;
(c) providing user interface for dynamically assigning attributes to said objects;
(d) selectively displaying, through a user interface, at least one container; an object is displayed in said container if a condition is met; the condition is applied to at least the following: at least one of the attributes of the container and at least one of the attribute of the object.

The invention provides for a system for sharing objects among community of users; the system includes at least one server communicating through a network with users, each being associated with a processor and associated memory and display that includes a respective set of attributes such that at least one attribute is common to at least two of said users; the respective processor and associated memory and display are configured to executing the following steps that include:
(a) providing a user replica that includes objects that are assigned, each, with at least one attribute;
(b) providing a set of containers associated, each, with attributes from among said set;
(c) providing a user interface for generating an update in said replica;
(d) submitting through said at least one server the update stipulated in step c to the replicas of selected users;
(e) receiving through said at least one server at least one update from at least one user in the community and update said user replica with the so received update; and
(f) selectively displaying, through a user interface, at least one container; an object from the replica is displayed in said container if a condition is met; the condition is applied to at least the following: at least one of the attributes of the container and at least one of the attribute of the object.

The invention further provides for a program storage device readable by machine, tangibly embodying a program of instructions executable by the machine to perform method steps for managing objects for at least one user, comprising:
(a) providing a set of attributes;
(b) providing a set of containers, each associated with attributes from among said set;
(c) providing user interface for dynamically assigning attributes to said objects;
(d) selectively displaying, through a user interface, at least one container: an object is displayed in said container if a condition is met; the condition is applied to at least the following: at least one of the attributes of the container and at least one of the attribute of the object.

The invention further provides for a computer program product comprising a computer useable medium having computer readable program code embodied therein for managing objects for at least one user, the computer program product comprising:
computer readable program code for causing the computer to provide a set of attributes;
computer readable program code for causing the computer to providing a set of containers, each associated with attributes from among said set;
computer readable program code for causing the computer to provide user interface for dynamically assigning attributes to said objects;
computer readable program code for causing the computer to selectively displaying, through a user interface, at least one container; an object is displayed in said container if a condition is met; the condition is applied to at least the following: at least one of the attributes of the container and at least one of the attributes of the object.

A typical (but not exclusive) bookmark sharing application includes the following characteristics:
Common attributes: the community all uses the same set of attributes. Each user builds its own user interface, by this particular example tree, of folders, associating attributes to each folder. Each bookmark is also assigned with attributes which are used to display the bookmark in the appropriate folders of each user (if a condition is met). The list of attributes can be updated, e.g. new attributes can be inserted and/or others may be deleted.
Replication: a database of all bookmarks is kept in a server to which all users have access. Preferably, local replicas of this database are kept in each user's machine. The replication enables users inter alia to work off-line (while not connected to a server), and provides much better performance.
Privacy: users may easily define some URLs (and possibly attributes) as private. Privately marked URLs are encrypted in the server and in the replicas of that user, so that access is possible only using the key of the user. Privacy may be regarded as an attribute that is associated with selected folders. Bookmarks can be dynamically assigned to folders and by the preferred embodiment they inherent the attributes of the folder. Thus bookmark that are assigned to private folders inherit the privacy attribute. Other attributes may be assigned to folders such as, for example, History signifying that bookmarks associated to this folder have just been recently used. Another non-limiting example, is Hot attribute associated to a folder that includes all those bookmarks which have just been recently added to folders.
Simple, familiar view user interface: the implementation uses a familiar tree folder structure user interface, allowing the user to perform common operations with click and drop user interface. The approach resembles a known user interface, such, for example, in the MICROSOFT™ folder explorer utility, and therefore reduces the time it takes to become familiar with the user interface. The drag and drop operation is utilized by one embodiment to assign attributes to bookmarks). Having mapped the bookmark to a folder the attributes of the folder are automatically assigned to the bookmark.
Display of bookmarks in folders through familiar user interface. As will be explained in greater detail below assignment of attributes to bookmarks, e.g. by drag and dropping the specified bookmark to a folder does not necessarily mean, that the bookmark will be displayed in the specified folder. As will be elaborated in greater detail below, in order for the bookmark to be displayed in the folder, it must meet a condition(s) that is (are) applied to the attributes of the container and the bookmark.

It should be noted that the term user should not be construed in a narrow manner. Thus, for example, a given user may have two distinct user applications running on the same or different machines.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIGS. 1a-b illustrate sample user interface view represented as a tree of folders, in accordance with one embodiment of bookmark sharing application;

FIG. 2 illustrates a block diagram of a generalized system architecture in accordance with the invention.

FIGS. 3a-d illustrate a user view before and after the insertion of an object;

FIGS. 4a-c illustrate an update sequence of operation in accordance with one embodiment of the invention;

FIG. 5 illustrates an exemplary attributes dialog box, in accordance with on embodiment of the invention;

FIG. 6 illustrates a user interface view in accordance with one embodiment of the invention; and

FIG. 7 illustrates bookmark dialog box in accordance with one embodiment of the invention.

### DETAILED DESCRIPTION OF A PREFERRED EMBODIMENT

Whilst, for simplicity, the discussion below pertains to a bookmark management and sharing application, the invention is by no means bound to bookmarks. Thus, bookmarks is only one out of many possible objects and accordingly other objects in addition or in lieu of the specified bookmarks, such as emails, files of various types, etc, or combination thereof.

Likewise, the description is mainly focused on tree of folders user interface, such as a Microsoft™ File Explorer like structure. Folders are only a non-limiting example of a self of containers and a tree is only a non-limiting example of arranging the set of containers.

A very popular interface for viewing bookmarks (as well as files, mail messages, etc.), is using a tree of folders, e.g. in accordance with the Microsoft file explorer user interface. In many applications, browsing the tree is a better way to look for the right bookmark, rather than doing a textual search in the database. However, organizing shared bookmarks into folders is difficult. The same URL may be relevant to more than one folder; furthermore, the different users may prefer a different arrangement of folders (e.g., one user prefers top level folder, “music” and sub-folder “shopping”, whereas another user prefers the other way around, i.e. top level folder “shopping” and sub-folder “music”), or simply a different name for folders (e.g., “find” and “search”).

A simple approach that purports to overcome this problem, is to decide on a fixed tree of folders used by all members of the community when entering bookmarks, possibly with some additional conventions. However, as explained above, such approach lacks flexibility, and it is hard to agree on commonly accepted and useful organization.

In accordance with one aspect of the invention, there is provided a community of users that agree on a set of attributes. Each user can build his/her set of containers and associate attributes to each container. It should be noted that whilst, preferably, the set of attributes is common to the users in the community, this is not necessarily always the case. Thus, users in the community may have a set of attributes, some of which are not necessarily shared by some or all of the other members in the community.

In accordance with one embodiment of the invention there is provided a user interface for dynamically adding, deleting or updating attributes in the set.

As will be explained in greater detail below, the attributes are used to display bookmarks in the appropriate folders of each user.

By one embodiment, the user defines a set of attributes. In the case of community of users, each user in a community defines a set of attributes that is relevant to the community's interests. The set of attributes is finite and yet dynamic. The procedure of addition of new attributes is explained in great detail below. In the case of community of users this set of attributes may be regarded as the “language” of the community.

The set of attributes is used to display bookmarks in, say tree of folders. A bookmark is displayed in a folder (or folders) if a condition is met. The condition is applied to at least the following: at least one of the attributes of the folder and at least one of the attribute of the bookmark. By a specific embodiment a bookmark is displayed in a folder if the bookmark and the folder share a common attribute.

To this end, objects (bookmarks) are dynamically assigned with attributes through user interface. By a specific embodiment the attributes are dynamically assigned to bookmarks using “drag and drop” operation. By this embodiment an object is mapped to a given container (folder) and inherits the attributes that are assigned to the specified container (folder).

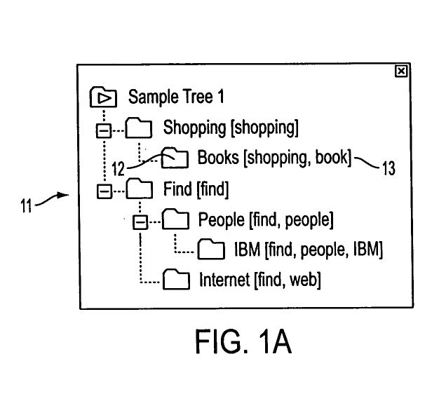

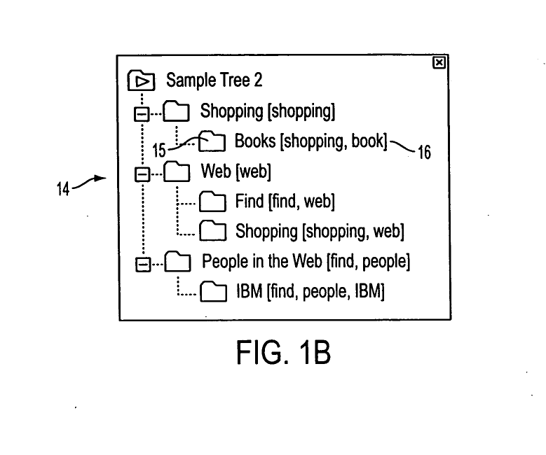

For a better understanding, attention is now directed to FIGS. 1A-B, illustrating a sample user interface represented as a tree of folders, in accordance with one embodiment of the invention.

Thus, the user interface 11 in FIG. 1A represented as a tree of folders (for, say, a first user in the community, or a single user in a stand-alone environment) similar to the known Microsoft™ file Explorer tree representation. Each folder (e.g. “books” (12)) is associated with attributes and by this particular embodiment “shopping” and “book” (13). In the user interface of FIG. 1A, attributes are embraced by square brackets. Sample folder tree 14 in FIG. 1B represents the user interface for, say, a second user in the community.

The list of URLs (or bookmarks) that corresponds to a given folder, are stored in the specified folder (not shown in FIGS. 1A and 1B), similar to files that belong to a given folder in the Windows Explorer utility.

The table below lists some examples of where bookmarks with specific attributes will be placed:

| Attributes | Sample Tree 1 | Sample Tree 2 |
|---|---|---|
| Shopping | Shopping | Shopping |
| Shopping, web | Shopping | Web > Shopping, Shopping |
| Shopping, web, | Shopping, | Shopping, Web > Shopping |
| find | Find > Internet | Web > Find |
| Find, people | Find > People | People in the Web |
| Find | Find | (Will not appear) |

By a specific embodiment of bookmark sharing, when a URL is inserted into a community database, the system creates a record that has three fields:
Key: The URL that the user wants to bookmark
Attributes: A set of attributes that is assigned to the URL's. Attributes are selected from a fixed set known to the community and maintained by the server. Each user may suggest additional attributes, and the server administrator decides whether or not the update (by this particular embodiment the so added attributes) will be submitted to the community. The display of bookmarks into folders is done according to their attributes, normally by applying a condition to the attributes of the folder and the attributes of the bookmark. For example, a bookmark is displayed in a folder if they share a common, attribute. It is therefore desirable that the community understands the attributes. Consequently, it would be desired (although not obligatory) that the bookmark sharing technique of the invention would be applicable for small to medium communities.

By a specific embodiment, there are three types of attributes:
Global—an attribute that is shared throughout the community.
Private—an attribute that is private and used only by the user that inserted it. These attributes will not be submitted to other users in the community.
Submit—an attribute that a user feels should be added to the collection of attributes globally shared by the community. Initially, the attribute is local, but, as will be explained in greater detail below, the server can, later change them into global attributes.
URL related data: Additional information describing the URL. The related data may be generated automatically. Automatically generated data includes e.g. the bookmark title, time of insertion, importance, owner of the data, expiration date, etc.
   Viewing Bookmarks

After having assigned attributes to both the bookmarks and the folders the bookmarks can be displayed. Bookmarks are displayed through user interface, as illustrated e.g. in FIG. 1, and are organized e.g., into a tree of folders. Each folder has a name and being assigned with one or more attributes (taken from the set of attributes). As described above, attributes are also assigned to each bookmark. By a preferred embodiment, if the folder contains a sub-folder, and a bookmark has also the attributes of the sub-folder, the bookmark is only displayed in the sub-folder (as a finer categorization). This logic is implemented by the following rule:

A bookmark will appear in a folder if and only if:
The bookmark's attributes contain the folder
The bookmark does not appear in any folder contained in this folder.

As specified above, a bookmark is displayed in a folder if a condition is met. By this specific example the condition includes a sub-condition that stipulates that an attribute (at least one) assigned to the bookmark is contained in the attributes of the folder in which the bookmark is displayed. The condition further includes a sub-condition stipulated that the bookmark does not appear in any folder contained in this folder.

The specified condition(s) and the sub-conditions thereof are, of course, not obligatory. Condition(s) and sub-condition(s) which stipulate what bookmarks will be displayed in what folders may be determined in accordance with the particular application, all as required and appropriate.

As specified above, in accordance with the invention there is provided a user interface for enabling dynamic assignment of attributes to objects. In accordance with a preferred embodiment, using the same interface of FIG. 1, a drag and drop operation is used in order to insert/delete a bookmark. Thus, by this embodiment upon dragging a URL into a folder, the URL inherits the attributes of that folder. The operation is simple and intuitive.

Notice that the result of such a single drag and drop of a URL into a folder, may reside in mapping the URL into multiple folders having a subset of these attributes. The URL may be dragged to additional folders, thereby being assigned with more attributes as necessary. For example, dragging a bookmark to the folder books (12) in the user interface illustrated in FIG. 1A, will automatically assign the attributes shopping and book (13) that are associated with this folder. The side effect of this operation is that this bookmark will also be mapped to the folder books (15) in user interface (14) considering that the folder books (15) is also associated with attributes shopping and book (16). A user may also assign bookmark related data to a URL, such as level of importance, expiration date, etc. The submission of the specified update (from user interface (11)) to user interface (14) will be discussed in greater detail below.

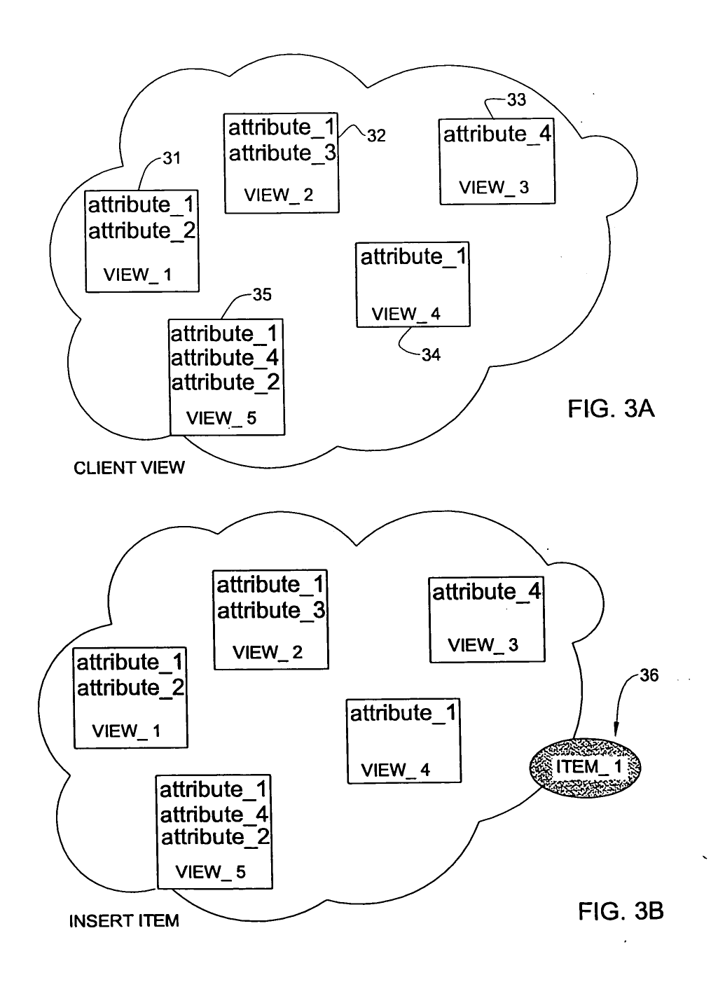

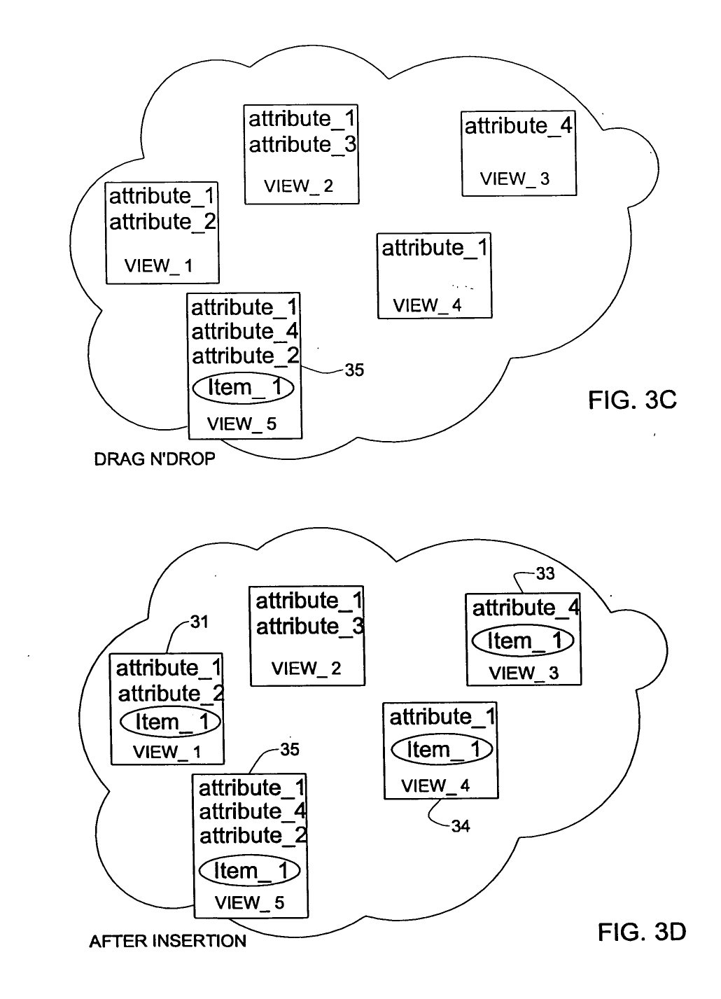

The consequence of a single drag and drop operation is further exemplified with reference to FIG. 3. FIG. 3A illustrates five user views (31 to 35). Having dragged and dropped item 1—say, a bookmark (36 in FIG. 3B) to View 5, item 1 is assigned with the 1, 2, and 4. Consequently, item 1 is automatically assigned to view 1 (31—due to attributes 1 and 2), view 3 (33—due to attribute 4) and view 4 (34—due to attribute 1). The update among the views is implemented in a manner that is described in detail below.

All users define their own individual tree of folders user interface. As mentioned above, the tree defines the folders used by the user to organize and subsequently display bookmarks. Users may edit their tree at any time. These operations are done on the user's machine and no one (i.e. other users or the server) can see the user tree view. In accordance with a preferred embodiment, the system of the invention includes a server that maintains the database of attributes and bookmarks; each member of the community runs a user application. The users are allowed to work off-line (i.e. a client can work even if the server is not running). In order to do so, the client must have a local replica of the data collected by the server. This is done using a data replication scheme between the client and the server. The replication protocol includes, by one embodiment, the following steps:
Initialization: Upon initialization, the user registers with the server and receives the current database and the community attribute list. The database may be organized in any known per se technique, e.g. relational database.
Updates: From time to time, at intervals determined by its internal clock, the client sends the server updates and receives updated information that was sent to the server by other users.

In accordance with a preferred embodiment, the update protocol concerns preferably only incremental updates, and therefore keeps communication overhead at a minimum. Because the user starts with the same database as the server and all client updates are done in the order specified by the server, both the user and server database contain the same information after the update process. This is the reason why incremental updates are sufficient. Note that if two users update the same bookmark, the updated information is determined by the last user to perform an update.

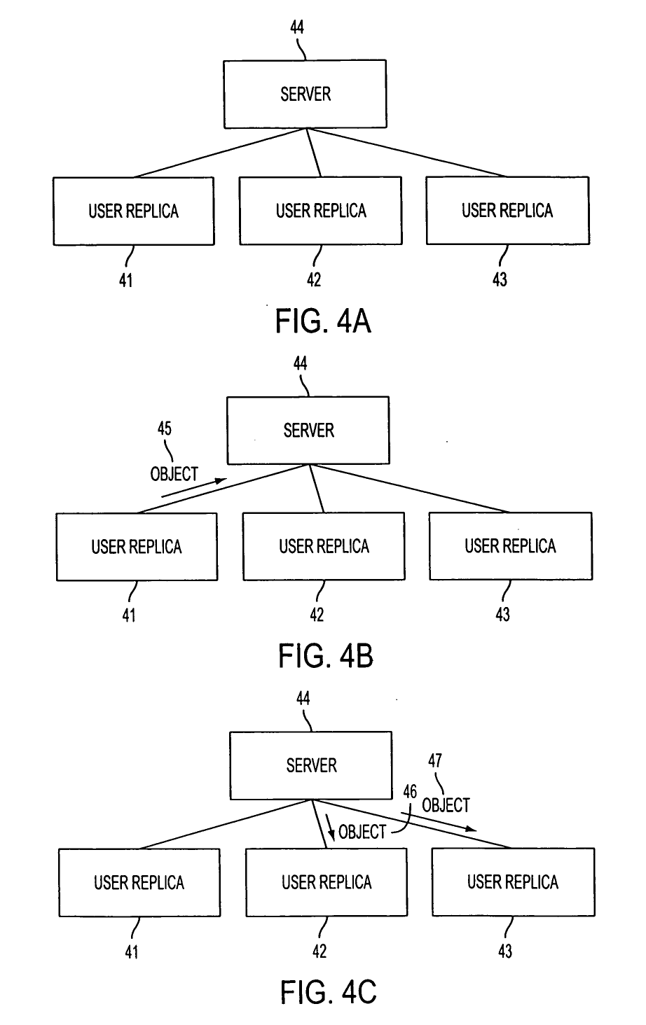

FIGS. 4a-c illustrate an update sequence of operation in accordance with one embodiment of the invention. Thus, FIG. 4a illustrates three user replica (41-43) interlinked to a database server (44). Each replica includes objects that are assigned with attributes. The assignments of attributes to objects were discussed above and will be further discussed below. By this embodiment, the replica may further include the user set of attribute and also the user set of containers. Considering, for example, that a user updates his replica with an additional object (45 in FIG. 4B) which he wishes to submit to other users, the update (by this particular example addition of an object) is submitted (46 and 47 in FIG. 4C) to the user replicas (42 and 43) through the server (44). The update is received in each replica, and when the user invokes the user interface for displaying objects in containers, the specified update is displayed, if applicable. Thus if the attribute(s) of the specified object and those of container(s) meet the condition, e.g. of the kind specified above the object is displayed in the container(s).

Privacy:

When a community shares information, it is important to maintain user privacy. Most users in a community, although they would like to share information, need to keep certain data private.

There follows a non-limiting embodiment where privacy is implemented. By this embodiment, the server stores all of the community data, therefore, certain information must be kept private from the server as well. Users can decide whether or not information will be shared or kept private.

Upon utilization, clients choose a password to protect their private data. The application then selects a random key (client's key), and encrypts it, using, say the DES encryption algorithm with the password as the secret key. The client then saves the encrypted key and uses it for login purposes.

The system uses the client's key for encryption, and for setting up a shared key with the server, used for authentication.

When a user specifies a bookmark as private, the application, encrypts the data using, e.g. DES with the client's key. In this way, the server receives encrypted data; even the server cannot open this data nor can these data be shared with other members of the community. Note that when a client receives an encrypted bookmark, it uses its key to decrypt the data.

Since a single user may install the client on several machines, there must be a way for users to retrieve all their bookmark data (including private items). Hence, a user may export his password to a special encrypted password file. Whenever the user wants to install another client, he will be prompted to import the password file containing the encrypted key. The new client can retrieve the key provided that the same client password is used.

System Architecture

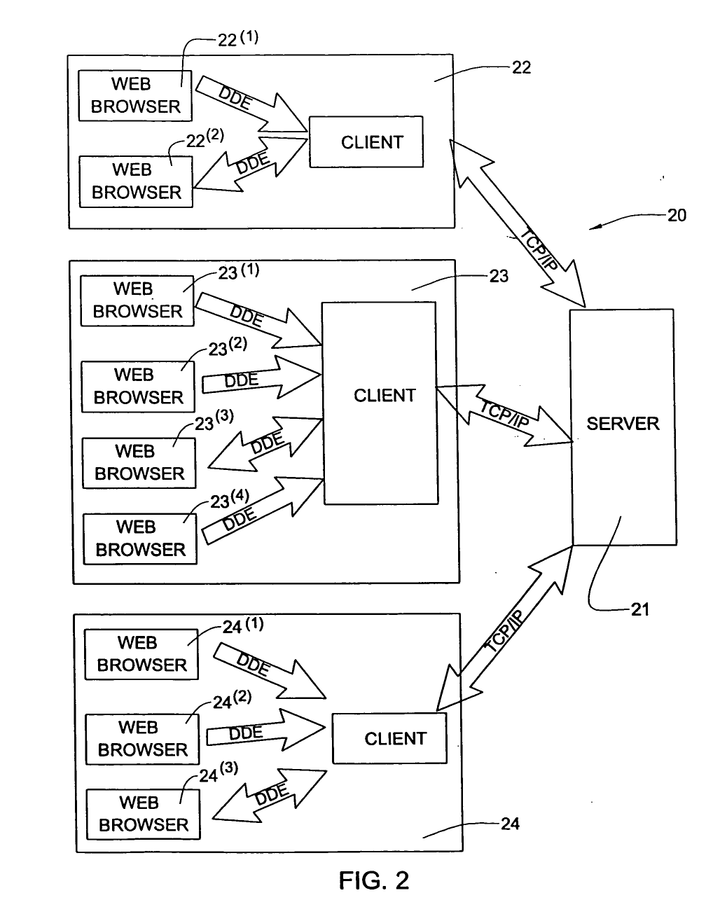

Turning now to FIG. 2, there is shown a block diagram of a generalized system architecture in accordance with one embodiment of the invention.

As shown, the system (20) has three components;
1. Server (21) that maintains the community bookmarks and manages the system.
2. Users (Clients) (of which only 22, 23 and 24 are shown in FIG. 2).
3. Web browsers 22⁽ⁱ⁾, 23⁽ⁱ⁾ and 24⁽ⁱ⁾ communicating with the respective clients (users).

Communication between the client and the server is done over TCP/IP; communication inside the client's machine, between the (possibly multiple) browsers and the client, is done using DDE protocol (see below). The invention is, by no means, bound by this specific implementation.

BY this embodiment, the system uses the DDE protocol to connect the client (e.g. 22) with the web browser (22¹ and 22²). Most web browsers implement the DDE (Dynamic Data Exchange) protocol for Windows (the DDE service name for Netscape is NETSCAPE, and for Microsoft™ is EXPLORE). The client uses certain known per se DDE methods to exchange data with the browser. The client records the URLs visited in each browser windows, even if there are several browser windows open. The client will open a URL, specified by the user, in the browser window that was last opened (the active window).

This implementation provides the system with an easy way to manipulate bookmarks. There is no need to “cut” and “paste” a URL in order to insert a new bookmark.

The Server

The server (21) and client use TCP/IP to communicate with each other. The server performs the administrative tasks required to manage the bookmarks, global attributes, and server preferences. The server's user interface is quite simple.

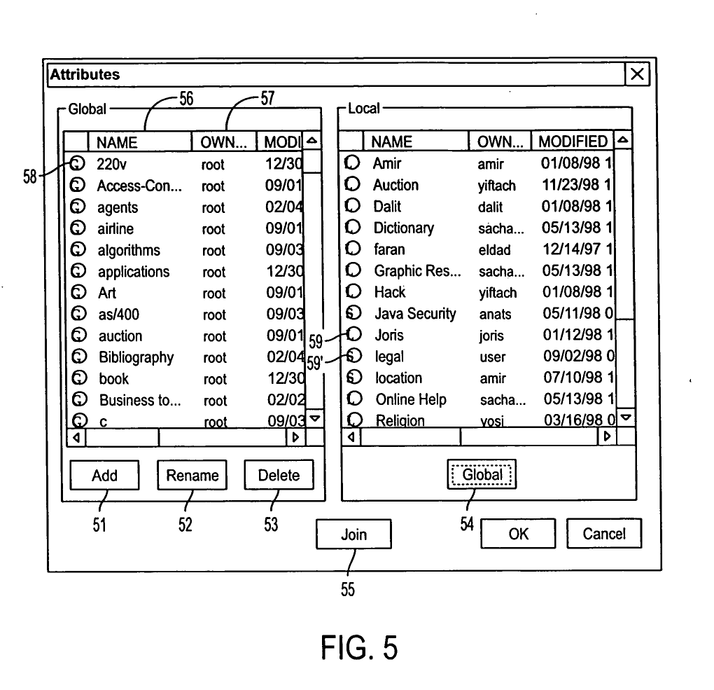

The server, as mentioned above, manages the system's collection of attributes. The attribute dialog box (user interface) shown in FIG. 5 displays all of the system's current attributes and includes user interface elements that enable the following operations:
Add:(51) adds a new global attribute
Rename:(52) renames a global attribute
Delete; (53) deletes a global attribute
Global:(54) modifies a local (private) attribute so that it becomes a global one.
Join:(55) takes either global or local attributes and combines them into one global attribute.

The field titles “name” (56) stands for the attribute name, own (57) stands for the attribute owner. The symbols (G) e.g. (58), (L) e.g. (59) and (S) e.g. (59′) stand for Global, Local and Submit, respectively.

“Global” attributes, which, as specified above, are shared among all the community users owned by the server (root), whereas “Local” and “Submit” attributes are owned by the corresponding client (user).

The user interface described with reference to FIG. 5 may be utilized by each user in the community for updating attributes of his/her own set. The so updated attributes may then be submitted in the (periodic) update to selected (or all) users in the community, e.g. in accordance with the protocol described schematically with reference to FIG. 4.

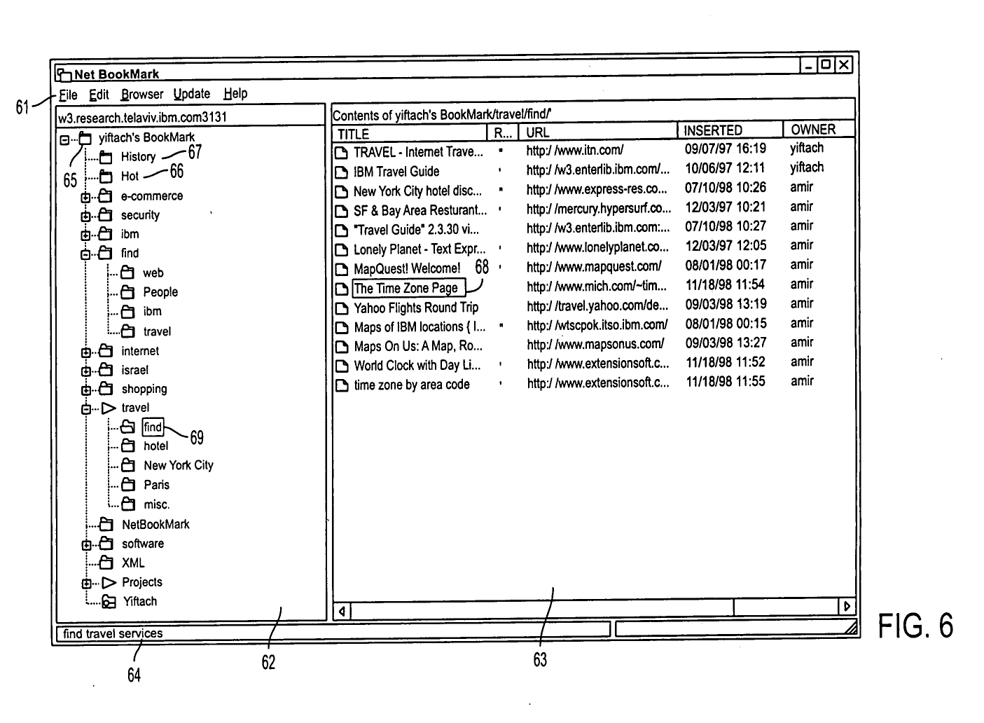

Turning now to the client, the user interface (shown in FIG. 6), is used to access bookmark and add bookmarks to the community's collection. Its appearance resembles the Windows Explorer. The client also enables the user to perform tasks such as editing the tree, assigning attributes to folders or bookmarks, opening a bookmark in the active browser window, and so forth.

By this specific embodiment, the client user interface has the following items:
Menu bar (61)—includes options for File, Browser, Update, Attributes and Help
Left window (62)—displays the folder hierarchy or “tree”. Users can click a folder's name to see its contents displayed in the right window.
Right window (63)—displays the contents (either bookmarks or sub-folders) of the folder selected in the left window. Folder contents can be sorted according to Title, Rating, ORL, Date or Owner.
Status bar (64)—runs along the bottom of the program window and displays the attributes of the bookmark or folder that is currently selected.

By this particular example, there are provided the following pre-defined folders:
Root (65)—the root of the folder hierarchy or “tree” and is titled “username's Bookmarks”. Any new folder created is displayed beneath this one, and known per se Hot (66) and History (67).

FIG. 6 illustrates the user interfaces where the containers (folders) and objects (bookmarks) are displayed.

By the specific example of FIG. 6, the highlighted URL (entitled “the time zone page” (68)) is inserted to the highlighted folder find (69) and is assigned with the attributes “find” and “travel” (64), as shown in the status bar. The condition that is applied to the bookmark and the folder is as before, i.e. a bookmark is displayed if the attributes thereof are included in those of the folder and it does not appear in a sub-folder thereof.

The user may create folders having the following attributes, for example:
Public or shared—These are folders that contain any type of bookmark.
Private—These folders include the “Private” attribute which ensures that URL is dragged into this folder, will be marked “private” by default, and kept encrypted in the database
Separator—A folder without attributes, i.e. the attribute NULL is associated thereto. This is useful to collect several folders which have a common utility but no common attributes, for example, to collect multiple projects under a single “projects” separator, or to collect several cities under the “travel”
Folders that do not yet contain attributes (and therefore do not contain bookmarks)

By this specific embodiment, bookmarks are one of two types:
Public bookmarks—shared with the rest of the community that is connected to the server.
Private bookmarks—specified as private and can only be viewed from that owner's client.
   Set or Edit a Bookmark

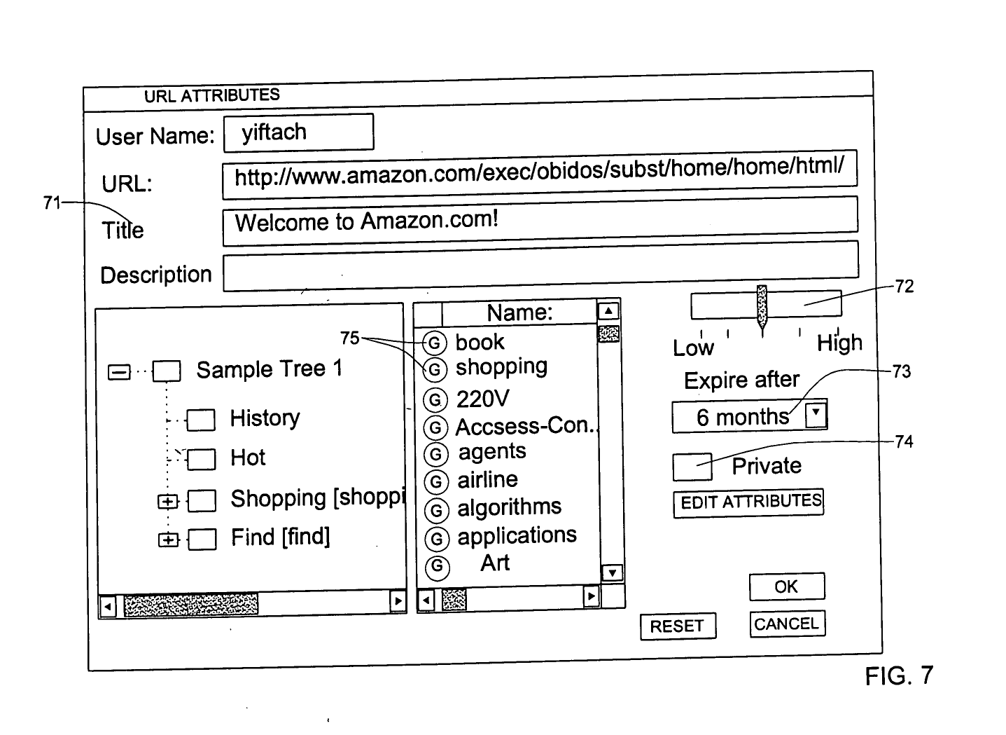

To set the attributes of a bookmark, users can do, by one embodiment, one of the following;
1. Drag the bookmark into a folder. The bookmark automatically inherits the folder's attributes.
2. Select a URL (bookmark) so that its name is highlighted and then set its attributes using the URL Attributes dialog user interface as is displayed in the non-limiting example of FIG. 7.
   Add a Title and Description to the URL (71) Users are not required to fill in this information, but this description will help the community use the bookmark more efficiently.
   Set the importance rating for a bookmark (72). Low indicates a less important bookmark and High indicates a more useful or important site.
   Set the bookmark to be automatically deleted after a specified period of time. (73)
   Mark a bookmark as Private to prevent it from being shared with other users. (74) p By this specific example, the attributes that were assigned to the URL (75) are Book and Shopping.

Whilst the example above focused in shared application where information (i.e. bookmarks) is shared among users in a community, the “sharing” characteristic is not necessarily obligatory. Thus, for example the invention may likewise be applied to a stand-alone mode where objects are displayed in containers, through user interface, if for example the object and the container share at least one common attribute.

In a similar manner objects are dynamically assigned with attributed using a user interface, and by specific embodiment using the drag and drop operation in the manner specified.

Whilst the description above referred to add attribute, those versed in the art will readily appreciate that updating attributes is not bound to only addition of attributes and accordingly other attribute updates are supported, such as deleting of attributes. The invention is likewise not bound to the particular updates described above (e.g. attributes, objects, assigning of attributes to objects), and accordingly other updates may be utilized,. all as required and appropriate.

In the method claims that follow, alphabetic characters and roman symbols used to designate claim steps are provided for convenience only and do not imply any particular order of performing the steps.

The invention has been described with a certain degree of particularity, but various alterations and modifications may be carried out, without departing from the scope of the following claims:

1: A method according to claim 15, further adapted to manage objects for at least one user, comprising:
(1) providing said set of attributes;
(2) providing a set of containers, each associated with attributes from among said set of attributes;
(3) providing a user interface for dynamically associating attributes to said objects;
(4) selectively displaying, through the user interface, at least one container; wherein an object is displayed in said container if a condition applied to at least one of the attributes of the container and at least one of the attributes of the object is met.

2: The method according to claim 1, wherein said associating, stipulated in step (3), includes mapping an object from among said objects to at least one container from among said containers and inheriting attributes of said container.

3-7: (canceled).

8: The method according to claim 2, wherein said mapping includes drag-and-dropping said object to said at least one container.

9-10: (canceled).

11: The method according to claim 15, further comprising the steps of:
categorizing selected objects as private; and
encrypting said objects with a user unique key.

12: The method according to claim 15, wherein selected containers in at least one of said user replicas are associated each with a private attribute; and further comprising the step of encrypting any object so associated to a container from among said containers using a unique key.

13: The method according to claim 1, wherein at least one of said objects further contains object-related-data selectively displayed in said user interface.

14: The method according to claim 1, further comprising the following step: applying at least one of the following to said set of attributes: adding at least one attribute, deleting at least one attribute updating at least one attribute.

15: A method for sharing objects among a community of users, wherein each user is associated with a respective set of attributes such that at least one attribute is common to at least two of said users, the method comprising executing the following steps with respect to the users in the community:
(a) providing to said users respective user replicas having, each, replica structure storing objects that are associated, each, with at least one attribute;
(b) providing for the user at least one user display tree having a tree structure different than and independent of said replica structure; the display tree including containers associated, each, with at least one attribute from among said set of attributes; wherein modification of at least one container in said tree does not require communication of objects with any other user in the community:
(c) each one of said selected users displaying said tree of containers, wherein an object is displayed in a container if a condition applied to at least one of the attributes of the container and at least one of the attributes of the object is met; the condition including a sub-condition that at least one attribute of the object contains at least one attribute of the container; wherein for at least one of said selected users (i) there exists an object displayed in at least two of said containers where the at least one attribute of each container is a subset of the at least one attribute of the object, and (ii) there exists an object displayed in a container if the object being associated with attributes containing but not equal to the at least one attribute of the container.

16: The method according to claim 15, wherein the set of attributes associated with each user forms part of the user replica.

17: The method according to claim 33, wherein said update includes associating attributes to said objects.

18: The method according to claim 33, wherein said update includes updating an object.

19 The method according to claim 33, wherein said update includes updating at least one attribute in said set of attributes; said updating of said at least one attribute is selected from the group that includes: adding an attribute, deleting an attribute, editing an attribute, change status of attribute from Global to Local or Local to Global, or joining two or more attributes into a single attribute.

20-21: (canceled).

22: The method according to claim 33, wherein said user interface includes a tree of containers.

23: The method according to claim 22, wherein said sub-condition is that an object is displayed in the container only if it is not displayed in a sub-container thereof.

24 The method according to claim 15, wherein said tree is displayed in a hierarchical, expandable and contractable manner, and wherein said containers comprise folders.

25: The method according to claim 15, wherein at least one of said objects is a URL bookmark of a web site.

26: The method according to claim 15, wherein at least one of said objects is a file.

27: The method according to claim 15, wherein at least one of said objects further contains object-related-data selectively displayed in said user interface.

28: (canceled).

29: A system for sharing objects among a community of users, wherein the system includes at least one server communicating through a network with users, each user being associated with a processor and associated memory and display that includes a respective set of attributes such that at least one attribute is common to at least two of said users, and the at least one server and respective processor and associated memory and display are configured to perform at least the following steps:
(a) providing to each respective user, a replica having replica structure storing objects that are associated, each, with at least one attribute;
(b) providing for the user at least one user display tree having a tree structure different than and independent of said replica structure: the display tree including containers associated, each, with at least one attribute from among said set of attributes; wherein modification of at least one container in said tree does not require communication of objects with any other user in the community;
(c) each one of said selected users displaying said tree of containers, wherein an object is displayed in a container if a condition applied to at least one of the attributes of the container and at least one of the attributes of the object is met; the condition including a sub-condition that at least one attribute of the object contains at least one attribute of the container, wherein for at least one of said selected users (i) there exists an object displayed in at least two of said containers where the at least one attribute of each container is a subset of the at least one attribute of the object, and (ii) there exists an object displayed in a container if the object being associated with attributes containing but not equal to the at least one attribute of the container; and
(d) selectively displaying, through a user interface, at least one container; an object from the replica is displayed in said container if a condition is met; the condition is applied to at least the following: at least one of the attributes of the container or at least one of the attributes of the object.

30-31: (canceled).

32: A program storage device readable by machine, tangibly embodying a program of instructions executable by the machine to perform method steps for sharing objects among community of users; each user is associated with a respective set of attributes such that at least one attribute is common to at least two of said users; the method comprising executing the following steps for each user in the community:
(a) providing a user replica that includes objects that are assigned, each, with at least one attribute;
(b) providing a set of containers associated, each, with attributes from among said set;
(c) providing a user interface for generating an update in said replica;
(d) submitting the update stipulated in step c to the replicas of selected users;
(e) receiving at least one update from at least one user in the community and updating said user replica with the received update; and
(f) selectively displaying, through a user interface, at least one container; an object from the replica is displayed in said container if a condition is met; the condition is applied to at least the following: at least one of the attributes of the container, or at least one of the attribute of the object.

33: The method according to claim 15, further comprising:
(d) generating an update in said replica;
(e) submitting the update stipulated in step (c) to the selected users;
(f) each one of said selected users receiving the update and updating said user replica with the received update.

34: A method for sharing objects among a community of users, wherein a user is associated with a set of attributes such that at least one attribute is common to at least two of said users, the method comprising:
(a) the user receiving a user replica having replica structure storing objects that are associated, each, with at least one attribute;
(b) the user providing at least one user display tree having a tree structure different than and independent of said replica structure; wherein the display tree includes containers associated, each, with at least one attribute from among said set of attributes; wherein modification of at least one container in said tree does not require communication of objects with any other user in the community;
(c) the user displaying said tree of containers, wherein an object is displayed in a container if a condition applied to at least one of the attributes of the container and at least one of the attributes of the object is met, the condition including a sub-condition that at least one attribute of the object contains at least one attribute of the container, wherein (i) there exists an object displayed in at least two of said containers where the at least one attribute of each container is a subset of the at least one attribute of the object, and (ii) there exists an object displayed in a container if the object being associated with attributes containing but not equal to the at least one attribute of the container.

35: A system for sharing objects among a community of users, wherein a user is associated with a processor and associated memory and display that includes a set of attributes such that at least one attribute is common to at least two of said users, the processor and associated memory and display are configured to perform at least the following:
(a) receiving a user replica having replica structure storing objects that are associated, each, with at least one attribute;
(b) providing at least one user display tree having a tree structure different than and independent of said replica structure; wherein the display tree includes containers associated, each, with at least one attribute from among said set of attributes; wherein modification of at least one container in said tree does not require communication of objects with any other user in the community;
(c) displaying said tree of containers, wherein an object is displayed in a container if a condition applied to at least one of the attributes of the container and at least one of the attributes of the object is met, the condition including a sub-condition that at least one attribute of the object contains at least one attribute of the container, wherein (i) there exists an object displayed in at least two of said containers where the at least one attribute of each container is a subset of the at least one attribute of the object, and (ii) there exists an object displayed in a container if the object being associated with attributes containing but not equal to the at least one attribute of the container.

36: A program storage device readable by machine, tangibly embodying a program of instructions executable by the machine to perform method steps for sharing objects among a community of users, wherein a user is associated with a set of attributes such that at least one attribute is common to at least two of said users, the method comprising executing the steps of:
(a) the user receiving a user replica having replica structure storing objects that are associated, each, with at least one attribute;
(b) the user providing at least one user display tree having a tree structure different than and independent of said replica structure; wherein the display tree includes containers associated, each, with at least one attribute from among said set of attributes; wherein modification of at least one container in said tree does not require communication of objects with any other user in the community;
(c) the user displaying said tree of containers, wherein an object is displayed in a container if a condition applied to at least one of the attributes of the container and at least one of the attributes of the object is met, the condition including a sub-condition that at least one attribute of the object contains at least one attribute of the container, wherein (i) there exists an object displayed in at least two of said containers where the at least one attribute of each container is a subset of the at least one attribute of the object, and (ii) there exists an object displayed in a container if the object being associated with attributes containing but not equal to the at least one attribute of the container.
